(19) United States
(12) Patent Application Publication
(10) Pub. No.: US 2016/0262048 A1
(43) Pub. Date: Sep. 8, 2016

(54) AMPLIFY AND FORWARD TECHNIQUES TO REDUCE COLLISIONS IN WIRELESS COMMUNICATION SYSTEMS

(71) Applicant: QUALCOMM Incorporated, San Diego, CA (US)

(72) Inventors: Alfred Asterjadhi, San Diego, CA (US); Bin Tian, San Diego, CA (US)

(21) Appl. No.: 15/061,877

(22) Filed: Mar. 4, 2016

Related U.S. Application Data
(60) Provisional application No. 62/128,905, filed on Mar. 5, 2015.

(51) Int. Cl. H04W 28/04; H04B 7/08; H04W 72/08

(52) U.S. Cl. CPC H04W 28/044; H04W 72/082; H04B 7/0811

(57) ABSTRACT

Techniques are described for wireless communication. In one method, a transmitter may generate a sequence of preambles including an amplify and forward (AF) preamble, an indication that the AF preamble is present, and an indication of at least one intended receiver for the sequence. The transmitter may transmit the sequence of preambles to the at least one intended receiver over a radio frequency spectrum. In another method, a receiver may receive the sequence of preambles over the radio frequency spectrum; determine that the receiver is an intended receiver based at least in part on the indication of at least one intended receiver for the sequence; amplify the received AF preamble; and forward the amplified AF preamble over the radio frequency spectrum.

### CROSS REFERENCES

The present Application for Patent claims priority to U.S. Provisional Patent Application No. 62/128,905 by Asterjadhi et al., entitled “Amplify and Forward Techniques to Reduce Collisions in Wireless Communication Systems,” filed Mar. 5, 2015, assigned to the assignee hereof.

### BACKGROUND

1. Field of the Disclosure

The present disclosure, for example, relates to wireless communication systems, and more particularly to amplify and forward techniques to reduce collisions in wireless communication systems.

2. Description of Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a Wireless Local Area Network (WLAN), such as a Wi-Fi network (IEEE 802.11) may include wireless devices (e.g., access points (APs) or stations (STAs)) that may communicate with other wireless devices. An AP may be coupled to a network, such as the Internet, and may enable a station to communicate via the network (and/or communicate with other devices coupled to the access point).

Under some scenarios, communication between pairs of wireless devices may be impacted by hidden nodes. In some embodiments, a hidden node may be a node within the energy detection range of one wireless device, but not another wireless device. For example, a first AP may be within the energy detection range of a station, but not within the energy detection range of a second AP near the station. Thus, when the first AP determines the energy level on a radio frequency spectrum is low and begins transmitting to the station, the transmission by the first AP may collide with a transmission by the second AP, because the first AP was unable to detect that the second AP was using the radio frequency spectrum in the vicinity of the station.

### SUMMARY

The described features generally relate to various techniques for wireless communication. Such techniques may reduce the likelihood that parallel transmissions by hidden nodes collide. The techniques involve transmitting, receiving, and/or amplifying and forwarding an amplify and forward (AF) preamble. For example, a first wireless device may generate and transmit, over a radio frequency spectrum, a sequence of preambles including an AF preamble, an indication that the AF preamble is present, and an indication of at least one intended receiver for the sequence. When a second wireless device receives the sequence of preambles, the second wireless device may determine that it is an intended receiver of the sequence (e.g., based on the indication of the intended receiver(s)), amplify the received AF preamble, and forward the amplified AF preamble over the radio frequency spectrum. Transmission and forwarding of the AF preamble can enable the second wireless device to clear the radio frequency spectrum at an appropriate time, and can reduce transmission overhead.

In a set of illustrative examples, a method for wireless communication is described. In one configuration, the method may include generating a sequence of preambles comprising an AF preamble, an indication that the AF preamble is present, and an indication of at least one intended receiver for the sequence, and transmitting the sequence of preambles to the intended receiver(s) over a radio frequency spectrum.

In some embodiments of the method, the AF preamble may include a replica of at least one field of a preamble in the sequence of preambles. In some embodiments, the sequence of preambles may include at least one preamble configured according to a first radio access technology (RAT) of the at least one intended receiver, and the AF preamble may include a preamble recognizable to a receiver operating according to a second RAT. In some embodiments, the method may include identifying, in the sequence of preambles, a first duration for which the radio frequency spectrum is reserved, and identifying, in the AF preamble, a second duration for which the radio frequency spectrum is reserved. The second duration may be less than the first duration by at least a time period of one preamble in the sequence of preambles.

In some embodiments of the method, the sequence of preambles may include a Wi-Fi legacy preamble and a Wi-Fi high efficiency (HE) preamble. In some embodiments, the Wi-Fi legacy preamble and the AF preamble may have a same duration. In some embodiments, the method may include receiving, from at least one receiver, at least one indicator of an interference environment, and selecting a format of the AF preamble based at least in part on the at least one indicator of the interference environment.

In some embodiments, the method may include receiving, from the at least one intended receiver, a format indicator for the AF preamble, and selecting a format of the AF preamble based at least in part on the format indicator. In some embodiments, the method may include inserting a null transmission between another preamble and the AF preamble, or at a beginning of the AF preamble, or at an end of the AF preamble, or following the AF preamble, or a combination thereof. In some embodiments, the sequence of preambles may include an offset correction following the AF preamble.

In another set of illustrative examples, another method for wireless communication is described. In one configuration, the method may include generating a sequence of preambles including an indication of at least one intended receiver for the sequence; transmitting the sequence of preambles to the at least one intended receiver over a radio frequency spectrum; and monitoring the radio frequency spectrum for a responsive transmission of an AF preamble by the at least one intended receiver after transmitting the sequence of preambles.

In some embodiments, the method may include receiving the AF preamble, and transmitting a payload to the at least one intended receiver in response to receiving the AF preamble.

In a third set of illustrative examples, another method for wireless communication is described. In one configuration, the method may include receiving over a radio frequency spectrum, at a receiver, a sequence of preambles including an AF preamble and an indication of at least one intended receiver; determining that the receiver is an intended receiver based at least in part on the indication; amplifying the received AF preamble; and forwarding the amplified AF preamble over the radio frequency spectrum.

In some embodiments, the method may include determining, from the sequence of preambles, a first duration for which the radio frequency spectrum is reserved, and inserting, in the AF preamble, a second duration for which the radio frequency spectrum is reserved. The second duration may be less than the first duration by at least a time period of one preamble in the sequence of preambles.

In some embodiments, the method may include transmitting at least one indicator of an interference environment at the receiver. In these examples, the received AF preamble may have a format based at least in part on the interference environment.

In some embodiments, the method may include receiving a null transmission between one preamble and the AF preamble, or at a beginning of the AF preamble, or at an end of the AF preamble, or following the AF preamble, or a combination thereof. In some embodiments, the sequence of preambles may include an offset correction following the AF preamble.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows an example of a WLAN network;

FIG. 2 shows a block diagram of an apparatus for use in wireless communication, in accordance with various aspects of the present disclosure;

FIG. 3 shows a block diagram of an apparatus for use in wireless communication, in accordance with various aspects of the present disclosure;

FIG. 4 shows a block diagram of an apparatus for use in wireless communication, in accordance with various aspects of the present disclosure;

FIG. 5 shows a block diagram of an apparatus for use in wireless communication, in accordance with various aspects of the present disclosure;

FIG. 6 shows a block diagram of a wireless device for use in wireless communication, in accordance with various aspects of the present disclosure;

FIG. 7 is a timing diagram illustrating transmission of a sequence of preambles, in accordance with various aspects of the present disclosure;

FIG. 8 is a timing diagram illustrating transmission of a sequence of preambles, in accordance with various aspects of the present disclosure;

FIG. 9 is a timing diagram illustrating transmission of a sequence of preambles, in accordance with various aspects of the present disclosure;

FIG. 10 is a flow chart illustrating an example of a method for wireless communication, in accordance with various aspects of the present disclosure;

FIG. 11 is a flow chart illustrating an example of a method for wireless communication, in accordance with various aspects of the present disclosure;

FIG. 12 is a flow chart illustrating an example of a method for wireless communication, in accordance with various aspects of the present disclosure;

FIG. 13 is a flow chart illustrating an example of a method for wireless communication, in accordance with various aspects of the present disclosure; and

FIG. 14 is a flow chart illustrating an example of a method for wireless communication, in accordance with various aspects of the present disclosure.

### DETAILED DESCRIPTION

Under some scenarios, communication between pairs of wireless devices may be impacted by hidden nodes. The described techniques enable wireless devices to transmit, receive, and/or amplify and forward an AF preamble that, when forwarded by a receiver, helps the receiver to clear a radio frequency spectrum at an appropriate time. Forwarding of the AF preamble can also enable clearing of the radio frequency spectrum with reduced overhead.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

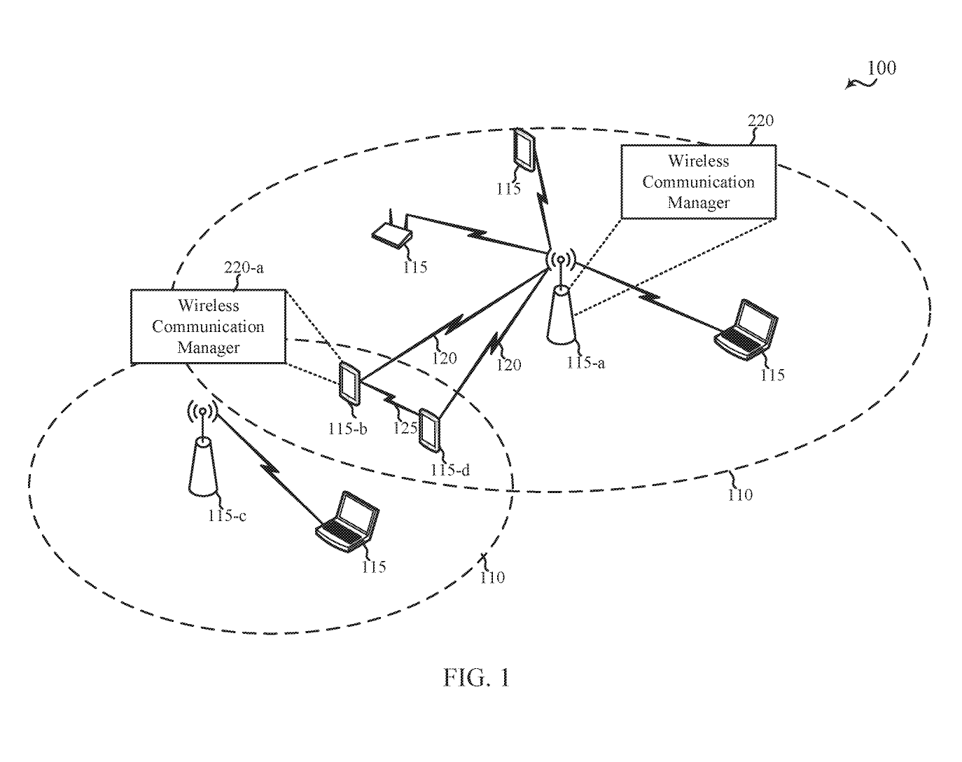

Referring first to FIG. 1, a block diagram illustrates an example of a wireless communication network 100 such as, e.g., a wireless local area network (WLAN) or network implementing at least one of the IEEE 802.11 family of standards. The network 100 may include a plurality of wireless devices 115, including, for example, a number of access points (e.g., wireless devices or APs 115-a and 115-c) and a number of stations (e.g., wireless devices or stations 115-b and 115-d). The stations may take forms such as personal computers (e.g., laptop computers, netbook computers, tablet computers, etc.), cellular telephones (including smart phones), PDAs, digital video recorders (DVRs), internet appliances, gaming consoles, e-readers, etc. Each of the stations (e.g., 115-b or 115-d) may alternatively be referred to as a mobile station (MS), a mobile device, an access terminal (AT), a user equipment (UE), a subscriber station (SS), or a subscriber unit. A station 115-b may associate and communicate with an AP 115-a via a communication link 120. Each AP (e.g., AP 115-a or 115-c) has a geographic coverage area 110 such that stations (e.g., stations 115-b and 115-d) within the geographic coverage area 110 of the AP can typically communicate with the AP. Stations may be dispersed throughout a geographic coverage area 110. Each station may be stationary or mobile.

As shown in FIG. 1, a station 115-b or 115-d can be within the coverage area of more than one AP 115-a and 115-c, and can therefore associate with different APs at different times. A single AP (e.g., AP 115-a or 115-c) and an associated set of stations may be referred to as a basic service set (BSS). An extended service set (ESS) is a set of connected BSSs. A distribution system (DS) (not shown) is used to connect APs in an extended service set. A geographic coverage area 110 for an AP may be divided into sectors making up a portion of the coverage area (not shown). The network 100 may include APs of different types (e.g., metropolitan area, home network, etc.), with varying sizes of coverage areas and overlapping coverage areas for different technologies.

While the stations 115-b or 115-d may communicate with each other through an AP 115-a using communication links 120, a station (e.g., station 115-b) may also communicate directly with another station (e.g., station 115-d) via a direct wireless link 125. Examples of direct wireless link 125 may include a Wi-Fi Direct connection, a connection established using a Wi-Fi Tunneled Direct Link Setup (TDLS) link, or another form of P2P group connection. The stations (e.g., stations 115-b and 115-d) shown in FIG. 1 may communicate according to the WLAN radio and baseband protocols, including physical and medium access control (MAC) layers, described in the IEEE 802.11 standard and its various versions, including, but not limited to, 802.11b, 802.11g, 802.11a, 802.11n, 802.11ac, 802.11ad, 802.11ah, etc. In other implementations, other peer-to-peer connections and/or ad hoc networks may be implemented within the communication network 100.

Under some scenarios, communication between pairs of wireless devices 115 may be impacted by hidden nodes. A hidden node is a node within the energy detection range of one wireless device 115, but not another wireless device. For example, the wireless device and/or AP 115-c may be within the energy detection range of the wireless device and/or station 115-b, but not within the energy detection range of the wireless device or access point 115-a. Thus, when the wireless device and/or AP 115-a determines the energy level on a radio frequency spectrum is low and begins transmitting to the wireless device and/or station 115-b, the transmission from the wireless device and/or AP 115-a may collide with a transmission by the wireless device and/or AP 115-c. The interference resulting from the collision may prevent the wireless device and/or station 115-b from receiving or properly decoding the transmission. The interference may also prevent a wireless device from receiving the transmission by the wireless device and/or AP 115-c.

As the density of networks increases, the number of hidden nodes can also increase, and the frequency of collisions between transmissions of hidden nodes can increase. This can reduce network throughput. In a Wi-Fi network, one way to reduce the frequency of collisions between transmissions of hidden nodes is to implement a Request to Send (RTS)/Clear to Send (CTS) protocol, in which a transmitter detects the energy level on a radio frequency spectrum and transmits an RTS to its intended receiver(s) upon determining the radio frequency spectrum is clear within the energy detection range of the transmitter. Upon receiving the RTS, an intended receiver may likewise detect the energy level on the radio frequency spectrum and transmit a CTS upon determining the radio frequency spectrum is clear within the energy detection range of the receiver. Upon the transmitter receiving a CTS from an intended receiver or receivers, the transmitter may transmit to the intended receiver(s). If the transmitter does not receive a CTS from a receiver, the transmitter may not transmit to the receiver. Although an RTS/CTS protocol (or RTS/CTS type of protocol) can be useful in mitigating collisions between transmissions of hidden nodes, it adds to the overhead of a transmission. It may also not work (e.g., when a network allocation vector (NAV) at a receiver is consistently non-zero). The wireless devices 115 shown in FIG. 1 may therefore include wireless communication managers 220 capable of transmitting and/or receiving amplify and forward (AF) preambles.

In some embodiments, the wireless device and/or AP 115-a may include a wireless communication manager 220 that generates and transmits a sequence of preambles including an AF preamble, an indication that the AF preamble is present, and an indication of an intended receiver (or receivers) for the sequence. When the wireless device and/or station 115-b receives the sequence of preambles using a wireless communication manager 220-a, the wireless device 115-b may determine that it is an intended receiver of the sequence (e.g., based on the indication of the intended receiver(s)), amplify the received AF preamble, and forward the amplified AF preamble over the radio frequency spectrum. Initial transmission and subsequent forwarding of the AF preamble may not provide closed loop feedback that the radio frequency spectrum is available at the wireless device 115-b. However, transmission and forwarding of the AF preamble can enable the wireless device 115-b to clear the radio frequency spectrum at an appropriate time, and with reduced transmission overhead.

In other embodiments, the wireless communication manager 220 of the wireless device and/or AP 115-a may generate and transmit a sequence of preambles including an indication of an intended receiver (or receivers) for the sequence. The wireless communication manager 220 may then monitor the radio frequency spectrum for a responsive transmission of an AF preamble by the wireless communication manager 220-a of the wireless device and/or station 115-b. Upon receiving the responsive transmission of the AF preamble, the AP 115-a may transmit a payload to the station 115-b.

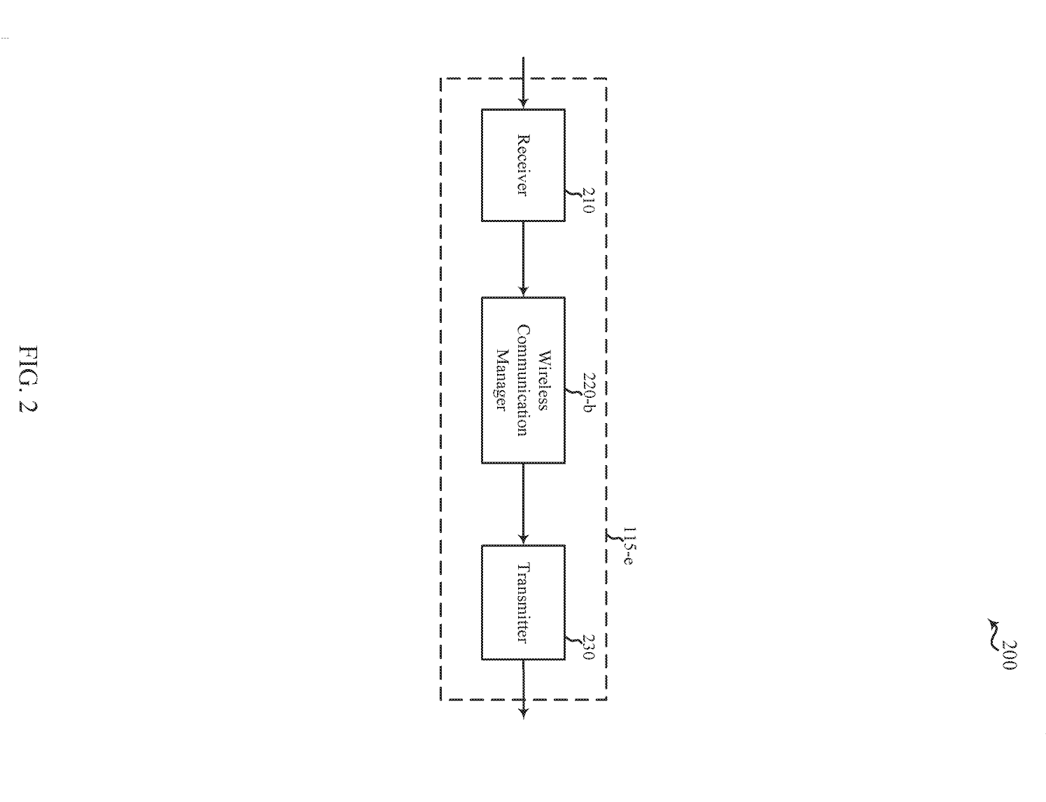

FIG. 2 shows a block diagram 200 of an apparatus 115-e for use in wireless communication, in accordance with various aspects of the present disclosure. In some examples, the apparatus 115-e may be an example of aspects of the wireless devices 115 described with reference to FIG. 1. The apparatus 115-e may also be or include a processor (not shown). The apparatus 115-e may include a receiver 210, a wireless communication manager 220-b, and/or a transmitter 230. Each of these components may be in communication with each other.

The modules of the first communication device 115-e may, individually or collectively, be implemented using at least one application-specific integrated circuit (ASIC) adapted to perform some or all of the applicable functions in hardware. Alternatively, the functions may be performed by at least one other processing unit (or core), on at least one integrated circuit. In other examples, other types of integrated circuits may be used (e.g., Structured/Platform ASICs, Field Programmable Gate Arrays (FPGAs), a System-on-Chip (SoC), and/or other types of Semi-Custom ICs), which may be programmed in any manner known in the art. The functions of each module may also be implemented, in whole or in part, with instructions embodied in a memory, formatted to be executed by at least one general and/or application-specific processor.

In some examples, the receiver 210 may include at least one radio frequency (RF) receiver. The receiver 210 and/or RF receiver may be used to receive various types of data and/or control signals (i.e., transmissions) over at least one communication link of a wireless communication system, such as at least one communication link of the wireless communication network 100 described with reference to FIG. 1.

In some examples, the transmitter 230 may include at least one RF transmitter. The transmitter 230 or RF transmitter may be used to transmit various types of data and/or control signals (i.e., transmissions) over at least one communication link of a wireless communication system, such as at least one communication link of the wireless communication network 100 described with reference to FIG. 1.

In some examples, the wireless communication manager 220-b may be used to manage at least one aspect of wireless communication for the apparatus 115-e. When the apparatus 115-e is a transmitter, and in one embodiment, the wireless communication manager 220-b may generate a sequence of preambles including an AF preamble, an indication that the AF preamble is present, and an indication of an intended receiver (or receivers) for the sequence. The wireless communication manager 220-b may also manage transmission of the sequence of preambles to the intended receiver(s), over a radio frequency spectrum, via the transmitter 230. The intended receiver(s) may include a single receiver or a plurality of receivers (e.g., a plurality of receivers communicating with the apparatus 115-e using multi-user OFDMA, MIMO, etc.). In the case of plural receivers, at least one of the receivers may transmit on top of the AF preamble (e.g., at the same time the AF preamble is being transmitted).

When the apparatus 115-e is a transmitter, and in another embodiment, the wireless communication manager 220-b may generate a sequence of preambles including an indication of an intended receiver (or receivers) for the sequence. The wireless communication manager 220-b may also manage transmission of the sequence of preambles to the intended receiver(s), over a radio frequency spectrum, via the transmitter 230. Still further, the wireless communication manager 220-b may manage a monitoring of the radio frequency spectrum for a responsive transmission of an AF preamble by the intended receiver(s). The responsive transmission may be received after the transmission of the sequence of preambles, in response to an intended receiver's receipt of at least a portion of the sequence of preambles.

When the apparatus 115-e is a receiver, the wireless communication manager 220-b may receive over a radio frequency spectrum, via the receiver 210, a sequence of preambles including an AF preamble and an indication of an intended receiver (or receivers). Based at least in part on the indication, the wireless communication manager 220-b may determine that it is an intended receiver of the sequence of preambles. Upon determining that it is an intended receiver of the sequence of preambles, the wireless communication manager 220-b may amplify the received AF preamble and forward the amplified AF preamble over the radio frequency spectrum (e.g., via the transmitter 230).

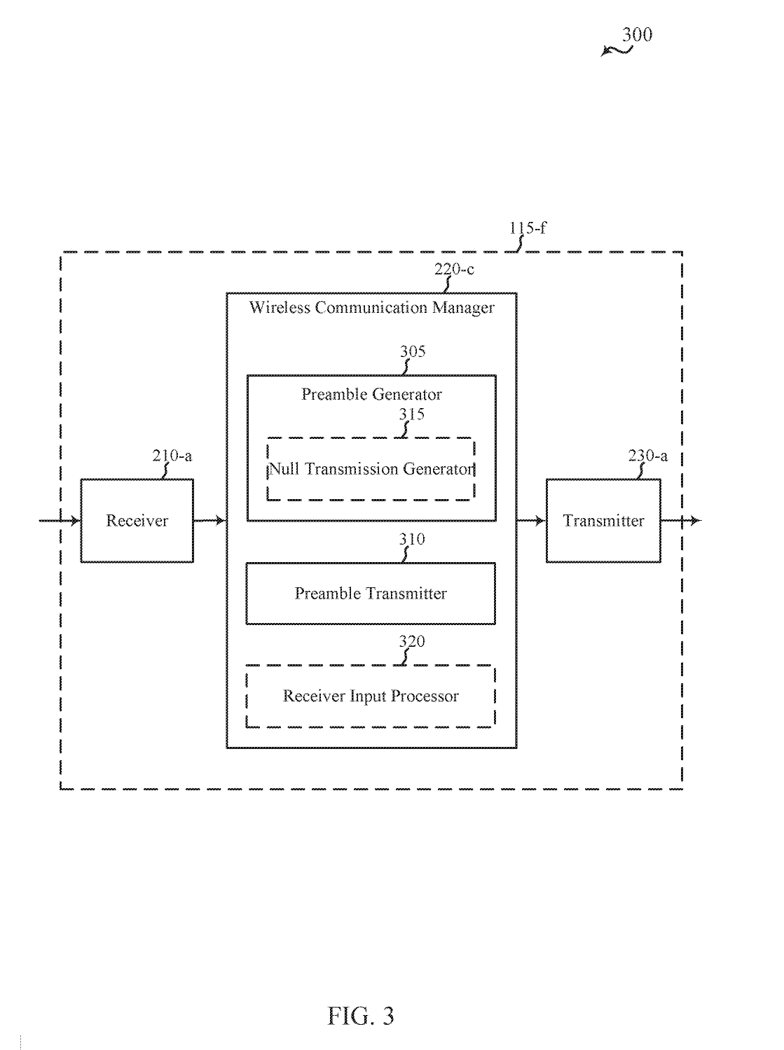

FIG. 3 shows a block diagram 300 of an apparatus 115-f for use in wireless communication, in accordance with various aspects of the present disclosure. In some examples, the apparatus 115-f may be an example of aspects of the wireless devices 115 described with reference to FIG. 1, or aspects of the apparatus 115-e described with reference to FIG. 2. The apparatus 115-f may also be or include a processor (not shown). The apparatus 115-f may include a receiver 210-a, a wireless communication manager 220-c, and/or a transmitter 230-a. Each of these components may be in communication with each other.

In some examples, the receiver 210-a, wireless communication manager 220-c, and transmitter 230-a may be respective examples of the receiver 210, wireless communication manager 220, and transmitter 230 described with reference to FIG. 2. As shown in FIG. 3, the wireless communication manager 220-c may include a preamble generator 305 and a preamble transmitter 310.

The preamble generator 305 may be used to generate a sequence of preambles including an AF preamble, an indication that the AF preamble is present, and an indication of an intended receiver (or receivers) for the sequence. In some examples, generating the sequence of preambles may include identifying, in the sequence of preambles, a first duration for which the radio frequency spectrum is reserved. Generating the sequence of preambles may also include identifying, in the AF preamble, a second duration for which the radio frequency spectrum is reserved, wherein the second duration is less than the first duration by at least a time period of one preamble in the sequence of preambles. Alternatively, the first duration or the second duration may be identified in the AF preamble, or a placeholder may be included in the AF preamble, and an intended receiver may replace the first duration, the second duration, or the placeholder with a duration determined by the intended receiver.

In some embodiments, the sequence of preambles generated by the preamble generator 305 may include a Wi-Fi legacy preamble and a Wi-Fi high efficiency (HE) preamble. In these embodiments, the first duration for which the radio frequency spectrum is reserved may be identified in a length field of the Wi-Fi legacy preamble, and the second duration, if provided, may be identified in a length field of the AF preamble. In some examples, the Wi-Fi legacy preamble may be a preamble that can be decoded by Wi-Fi devices compatible with older versions of the IEEE 802.11 standard, while the Wi-Fi HE preamble may be a preamble that can be decoded by Wi-Fi devices compatible with newer versions of the IEEE 802.11 standard. In some cases, older versions of the IEEE 802.11 standard which may decode the legacy preamble may include 802.11b, 802.11g, 802.11a, 802.11n, etc., and newer versions of the IEEE 802.11 standard which may additionally decode the Wi-Fi HE preamble may include 802.1 lax, etc., and future releases. These older and newer standards, however, are just examples, and the older and newer standards may include additional IEEE 802.11 standards than those listed here. In some examples, the Wi-Fi HE preamble may be transmitted using beam-forming operations and/or be transmitted at a higher power than the Wi-Fi legacy preamble, to provide higher efficiency (e.g., higher throughput) Wi-Fi communications for newer Wi-Fi devices.

In some cases, the Wi-Fi legacy preamble and the AF preamble may have a same duration or format. In other cases, the Wi-Fi legacy preamble and the AF preamble may have different durations or formats. In some cases, the AF preamble may include a replica of at least one field of a preamble in the sequence of preambles (e.g., a replica of at least one field of the Wi-Fi legacy preamble). In some cases, the AF preamble may be a substantial replica of the Wi-Fi legacy preamble. For example, the AF preamble may include the same fields as the Wi-Fi legacy preamble and have the same duration as the Wi-Fi legacy preamble. However, the AF preamble may have a length field indicating the second duration for which the radio frequency spectrum is reserved instead of the first duration.

In some embodiments, the sequence of preambles generated by the preamble generator 305 may include at least one preamble configured according to a first radio access technology (RAT) of the intended receiver(s), and the AF preamble may include a preamble recognizable to a receiver operating according to a second RAT. For example, in embodiments in which the sequence of preambles includes a Wi-Fi legacy preamble and a Wi-Fi HE preamble configured according to a Wi-Fi RAT of the intended receiver(s), the AF preamble may include a very high throughput (VHT) preamble or a Long Term Evolution (LTE) or LTE Advanced (LTE-A) (LTE/LTE-A) preamble.

In some embodiments, the sequence of preambles generated by the preamble generator 305 may include an offset correction following the AF preamble.

In some examples, the preamble generator 305 may include a null transmission generator 315. The null transmission generator 315 may insert a null transmission between another preamble and the AF preamble, at a beginning of the AF preamble, at an end of the AF preamble, following the AF preamble, or a combination thereof.

The preamble transmitter 310 may be used to manage transmission of the sequence of preambles to the intended receiver(s), over a radio frequency spectrum, via the transmitter 230-a.

In some examples, the wireless communication manager 220-c may further include a receiver input processor 320. The receiver input processor 320 may be used to receive, from at least one receiver, at least one indicator of an interference environment, a format indicator for an AF preamble, or a combination thereof. In some embodiments, the format of the AF preamble may be selected, by the preamble generator 305, based on a format indicator for the AF preamble (e.g., based on a format indicator received from an intended receiver). In some embodiments, the format of the AF preamble may be selected by the preamble generator 305 based on an indicator (or indicators) of an interference environment (e.g., based on an indicator of the type or quantity of interference that may be experienced by the intended receiver(s) of the sequence of preambles). In some cases, the indicator(s) of the interference environment may be received from at least one of the intended receivers. In some cases, the indicator(s) of the interference environment may be received from other receivers or devices, or from a combination of intended receivers, other receivers, and/or other devices.

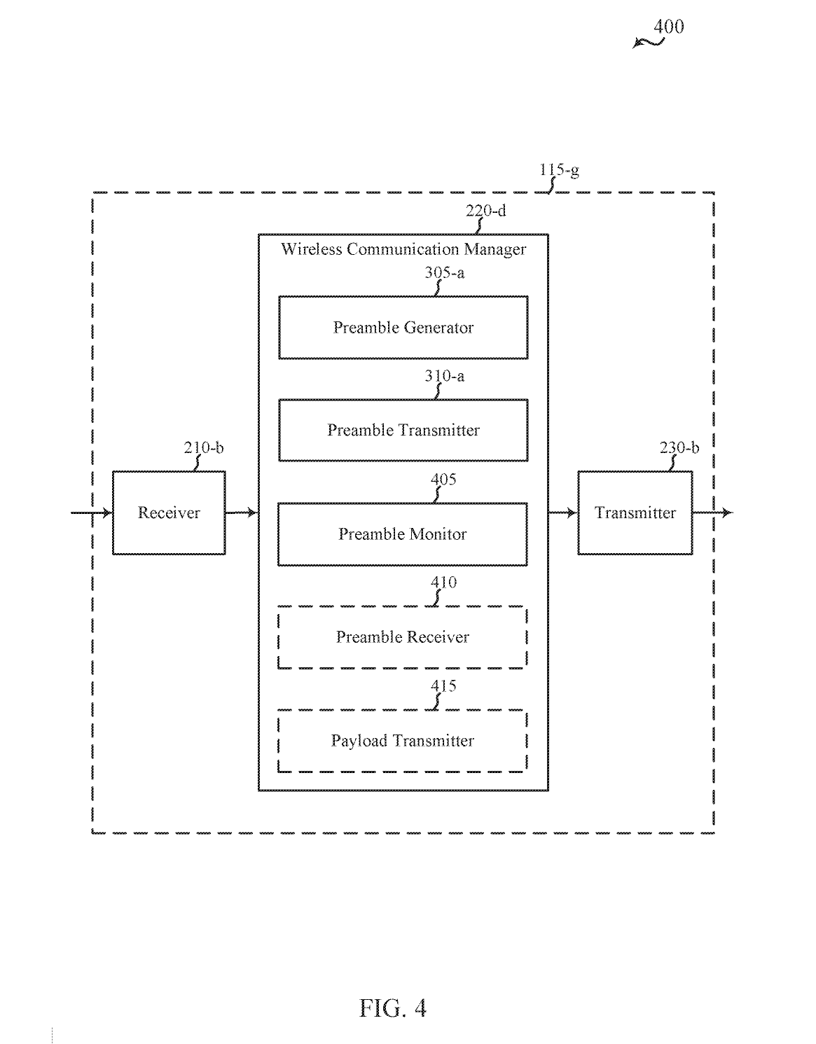

FIG. 4 shows a block diagram 400 of an apparatus 115-g for use in wireless communication, in accordance with various aspects of the present disclosure. In some examples, the apparatus 115-g may be an example of aspects of the wireless devices 115 described with reference to FIG. 1, or aspects of the apparatus 115-e described with reference to FIG. 2. The apparatus 115-g may also be or include a processor (not shown). The apparatus 115-g may include a receiver 210-b, a wireless communication manager 220-d, and/or a transmitter 230-b. Each of these components may be in communication with each other.

In some examples, the receiver 210-b, wireless communication manager 220-d, and transmitter 230-b may be respective examples of the receiver 210, wireless communication manager 220, and transmitter 230 described with reference to FIG. 2. As shown in FIG. 4, the wireless communication manager 220-d may include a preamble generator 305-a, a preamble transmitter 310-a, and/or a preamble monitor 405.

The preamble generator 305-a may be used to generate a sequence of preambles including an indication of an intended receiver (or receivers) for the sequence. The preamble transmitter 310-a may be used to manage transmission of the sequence of preambles to the intended receiver(s), over a radio frequency spectrum, via the transmitter 230-b. The preamble monitor 405 may be used to monitor the radio frequency spectrum for a responsive transmission of an AF preamble by the intended receiver(s) after transmitting the sequence of preambles.

In some examples, the wireless communication manager 220-d may further include a preamble receiver 410 and a payload transmitter 415. The preamble receiver 410 may be used to receive the AF preamble. Receipt of the AF preamble, from a receiver, may be considered an indication that the receiver is available to receive a transmission. The payload transmitter 415 may be used to transmit a payload to the intended receiver(s), in response to receiving the AF preamble.

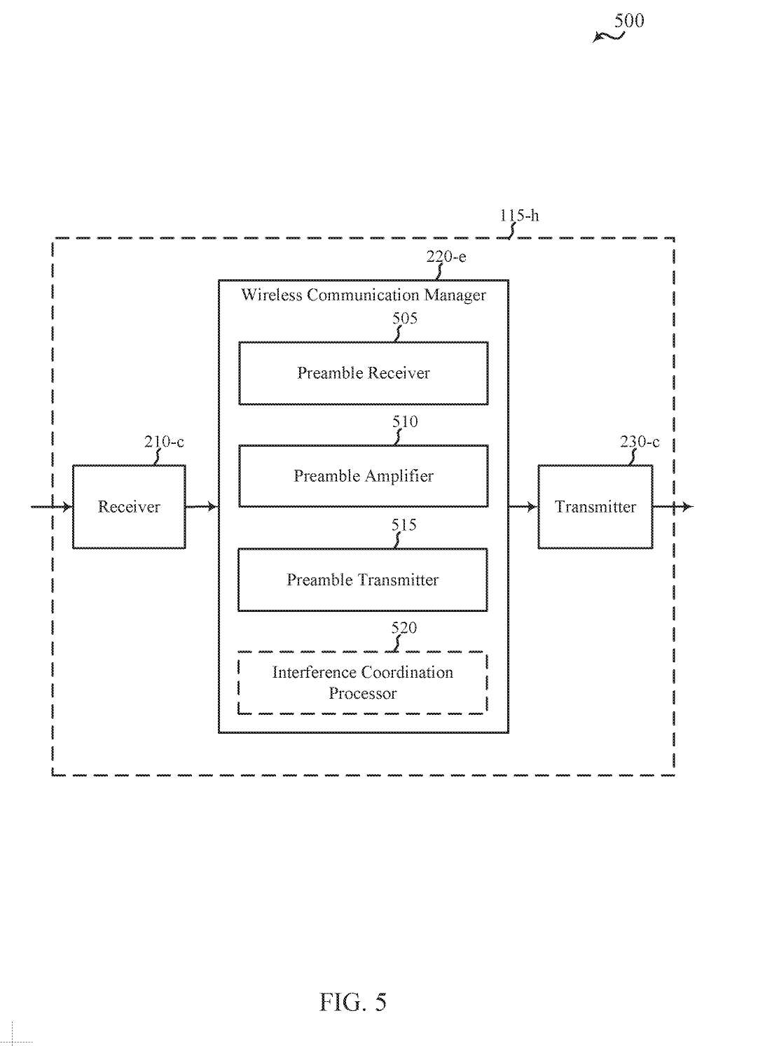

FIG. 5 shows a block diagram 500 of an apparatus 115-h for use in wireless communication, in accordance with various aspects of the present disclosure. In some examples, the apparatus 115-h may be an example of aspects of the wireless devices 115 described with reference to FIG. 1, or aspects of the apparatus 115-e described with reference to FIG. 2. The apparatus 115-h may also be or include a processor (not shown). The apparatus 115-h may include a receiver 210-c, a wireless communication manager 220-e, and/or a transmitter 230-c. Each of these components may be in communication with each other.

In some examples, the receiver 210-c, wireless communication manager 220-e, and transmitter 230-c may be respective examples of the receiver 210, wireless communication manager 220, and transmitter 230 described with reference to FIG. 2. As shown in FIG. 5, the wireless communication manager 220-e may include a preamble receiver 505, a preamble amplifier 510, and/or a preamble transmitter 515.

The preamble receiver 505 may be used to receive, over a radio frequency spectrum, a sequence of preambles including an AF preamble and an indication of an intended receiver (or receivers). In some embodiments, the sequence of preambles may also include an indicator (or indicators) that the AF preamble is present or an indicator of a first duration for which a radio frequency spectrum is reserved. The preamble receiver 505 may be used to identify the first duration.

The AF preamble received by the preamble receiver 505 may include an indicator of a second duration for which the radio frequency spectrum is reserved. Alternatively, the first duration or the second duration may be identified in the AF preamble, or a placeholder may be included in the AF preamble, and the receiver may replace the first duration, the second duration, or the placeholder with a duration determined by the receiver. The second duration may be less than the first duration by at least a time period of one preamble in the sequence of preambles.

In some embodiments, the sequence of preambles received by the preamble receiver 505 may include a Wi-Fi legacy preamble and a Wi-Fi HE preamble. In these embodiments, the first duration for which the radio frequency spectrum is reserved may be identified in a length field of the Wi-Fi legacy preamble, and the second duration, if provided, may be identified in a length field of the AF preamble. In some cases, the Wi-Fi legacy preamble and the AF preamble may have a same duration or format. In other cases, the Wi-Fi legacy preamble and the AF preamble may have different durations or formats. In some cases, the AF preamble may include a replica of at least one field of a preamble in the sequence of preambles (e.g., a replica of at least one field of the Wi-Fi legacy preamble). In some cases, the AF preamble may be a substantial replica of the Wi-Fi legacy preamble. For example, the AF preamble may include the same fields as the Wi-Fi legacy preamble and have the same duration as the Wi-Fi legacy preamble. However, the AF preamble may have a length field indicating the second duration for which the radio frequency spectrum is reserved instead of the first duration.

In some embodiments, the sequence of preambles received by the preamble receiver 505 may include at least one preamble configured according to a first RAT recognizable by the apparatus 115-h, and the AF preamble may include a preamble recognizable to a receiver operating according to a second RAT. For example, in embodiments in which the sequence of preambles includes a Wi-Fi legacy preamble and a Wi-Fi HE preamble configured according to a Wi-Fi RAT of the apparatus 115-h, the AF preamble may include a VHT preamble or an LTE/LTE-A preamble recognizable by an LTE/LTE-A receiver operating within an energy detection range of the apparatus 115-h.

In some embodiments, the sequence of preambles received by the preamble receiver 505 may include an offset correction following the AF preamble. In some embodiments, the preamble receiver 505 may further receive a null transmission between one preamble and the AF preamble, at a beginning of the AF preamble, at an end of the AF preamble, following the AF preamble, or a combination thereof.

The preamble receiver 505 may also be used to determine that the receiver is an intended receiver. The determination may be based on the indication of the intended receiver(s) included in the sequence of preambles.

The preamble amplifier 510 may be used to manage amplification of the received AF preamble.

The preamble transmitter 515 may be used to manage forwarding of the amplified AF preamble over the radio frequency spectrum.

In some examples, the wireless communication manager 220-e may further include an interference coordination processor 520. The interference coordination processor 520 may be used to determine an interference environment at the apparatus 115-h and/or transmit an indicator of the interference environment. The interference coordination processor 520 may also or alternatively be used to transmit a format indicator for the AF preamble, which format indicator may, in some cases, be based on a determined interference environment. The interference coordination processor 520 may also or alternatively be used to insert, in the AF preamble, the second duration for which the radio frequency spectrum is reserved.

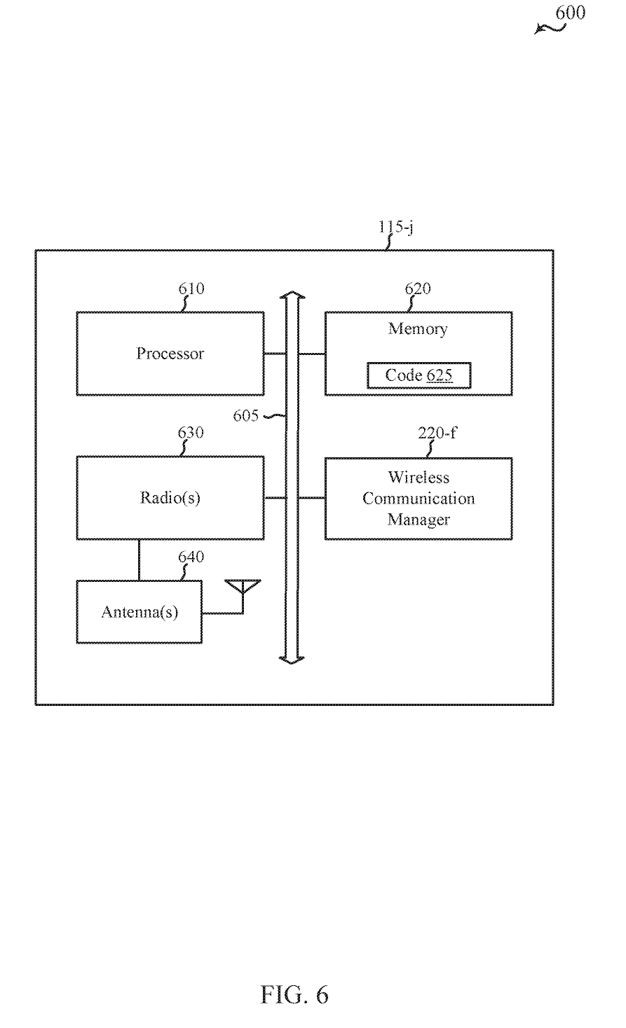

Turning to FIG. 6, a block diagram 600 of a wireless device 115-j for use in wireless communication is shown, in accordance with various aspects of the present disclosure. The wireless device 115-j may have various configurations and may be included or be part of a personal computer (e.g., a laptop computer, a netbook computer, a tablet computer, etc.), a cellular telephone (including a smart phone), a PDA, a digital video recorder (DVR), an internet appliance, a gaming console, an e-reader, etc. The wireless device 115-j may, in some examples, have an internal power supply (not shown), such as a small battery, to facilitate mobile operation. In some examples, the wireless device 115-j may be an example of aspects of the wireless devices or apparatuses 115 described with reference to FIGS. 1-5. The wireless device 115-j may implement at least some of the wireless device and/or apparatus features and functions described with reference to FIGS. 1-5.

The wireless device 115-j may include a processor 610, a memory 620, at least one radio 630, at least one antenna 640, or a wireless communication manager 220-f Each of these components may be in communication with each other, directly or indirectly, over at least one bus 605.

The memory 620 may include random access memory (RAM) or read-only memory (ROM). The memory 620 may store computer-readable, computer-executable code 625 containing instructions that, when executed, cause the processor 610 to perform various functions described herein related to wireless communication over a radio frequency spectrum. Alternatively, the code 625 may not be directly executable by the processor 610 but cause the wireless device 115-j (e.g., when compiled and executed) to perform various functions described herein.

The processor 610 may include an intelligent hardware device, e.g., a central processing unit (CPU), a microcontroller, an ASIC, etc. The processor 610 may process information received through the at least one radio 630 or information to be sent to the at least one radio 630. The processor 610 may handle, alone or in connection with the wireless communication manager 220-f, various aspects of communicating over (or managing communications over) a radio frequency spectrum.

The at least one radio 630 may include a WLAN radio (e.g., a Wi-Fi radio) and/or a WWAN radio (e.g., an LTE/LTE-A radio). Each radio may include or be associated with a modem that modulates packets and provide the modulated packets to at least one of the antenna(s) 640 for transmission, and to demodulate packets received from at least one of the antenna(s) 640. The radios 630 may, in some examples, be implemented as at least one radio receiver and at least one separate radio transmitter (e.g., the receiver 210 and the transmitter 230 described with reference to any of FIGS. 1-5). While the wireless device 115-j may include a single antenna, there may be examples in which the wireless device 115-j may include multiple antennas 640.

The wireless communication manager 220-f may perform or control some or all of the wireless device and/or apparatus features or functions described with reference to FIGS. 1-5. The wireless communication manager 220-f, or portions of it, may include a processor, or some or all of the functions of the wireless communication manager 220-f may be performed by the processor 610 or in connection with the processor 610. In some examples, the wireless communication manager 220-f may be an example of the wireless communication manager 220 described with reference to FIGS. 2-5.

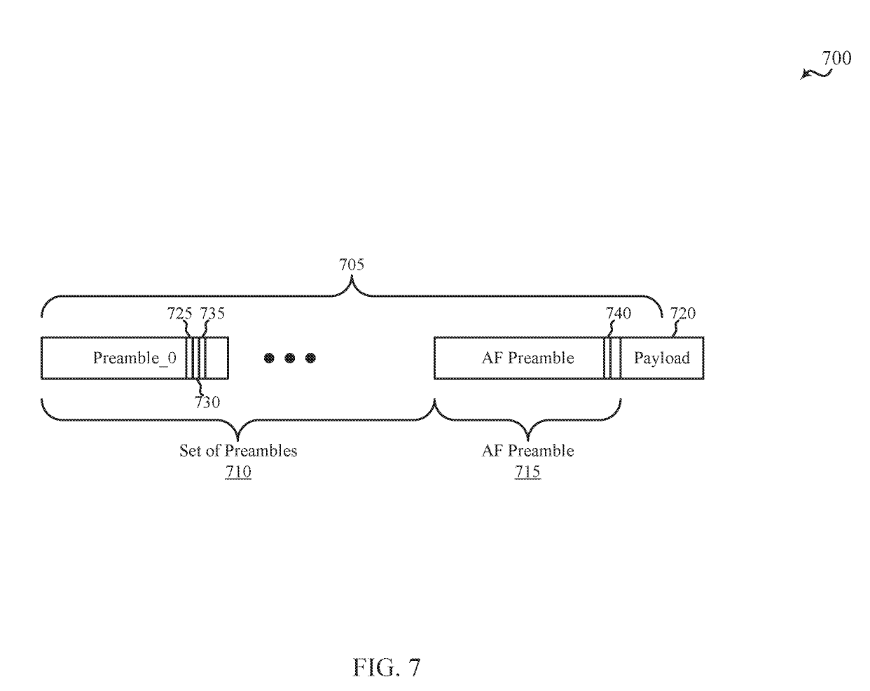

FIG. 7 is a timing diagram 700 illustrating transmission of a sequence of preambles 705, in accordance with various aspects of the present disclosure. In some examples, the sequence of preambles 705 may be an example of aspects of the sequence of preambles transmitted (or received) by any of the wireless devices or apparatuses 115 described with reference to FIGS. 1-6.

By way of example, the sequence of preambles 705 is shown to include a set of preambles 710 (i.e., at least one preamble) followed by an AF preamble 715. A number of payloads 720 may follow the AF preamble 715. The set of preambles 710 may include an indication 725 that the AF preamble 715 is present, and an indication 730 of an intended receiver (or receivers) for the sequence of preambles 705. The set of preambles 710 may also include an indication 735 of a first duration for which the radio frequency spectrum is reserved. The AF preamble 715 may include an indication 740 of a second duration for which the radio frequency spectrum is reserved. The second duration may be less than the first duration by at least a time period of one preamble in the sequence of preambles. For example, the second duration may be less than the first duration by a time period equal to the duration of the set of preambles 710. In some embodiments, the AF preamble 715 may be transmitted with the indication 740 of the second duration, the indication 735 of the first duration, or a placeholder, and an intended receiver of the sequence of preambles 705 may replace the indication 740, the indication 735, or the placeholder before (or when) it forwards the AF preamble 715.

In some embodiments, the sequence of preambles 705 may include at least one preamble configured according to a first RAT of the intended receiver(s), and the AF preamble 715 may include a preamble recognizable to a receiver operating according to a second RAT. For example, the set of preambles 710 may be configured according to a Wi-Fi RAT of the intended receiver(s), the AF preamble 715 may include a VHT preamble or an LTE/LTE-A preamble.

In some embodiments, a transmitter may transmit the set of preambles 710, and then monitor the radio frequency spectrum over which the preamble(s) 710 are transmitted for an AF preamble transmitted by an intended receiver of the sequence of preambles 705. Upon receiving the AF preamble, the transmitter may interpret the received AF preamble as an indication that the intended receiver is available to receive the number of payloads 720.

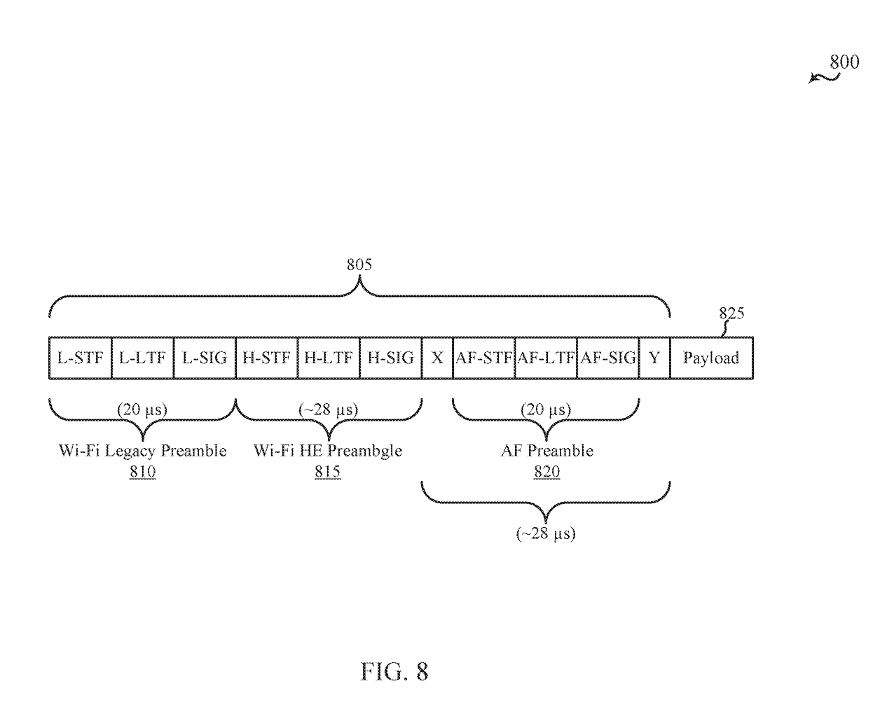

FIG. 8 is a timing diagram 800 illustrating transmission of a sequence of preambles 805, in accordance with various aspects of the present disclosure. In some examples, the sequence of preambles 805 may be an example of aspects of the sequence of preambles transmitted (or received) by any of the wireless devices or apparatuses 115 described with reference to FIGS. 1-6.

By way of example, the sequence of preambles 805 is shown to include a Wi-Fi legacy preamble 810, followed by a Wi-Fi HE preamble 815, followed by an AF preamble 820. A number of payloads 825 may follow the AF preamble 820. The Wi-Fi legacy preamble 810 may include a legacy short training field (L-STF), a legacy long training field (L-LTF), and a legacy signal field (L-SIG). The Wi-Fi HE preamble 815 may include an HE short training field (H-STF), an HE long training field (H-LTF), and an HE signal field (H-SIG). The AF preamble 820 may include an AF short training field (AF-STF), an AF long training field (AF-LTF), and an AF signal (AF-SIG) field. In some embodiments, each of the L-STF, L-LTF, L-SIG, H-STF, H-LTF, H-SIG, AF-STF, AF-LTF, and AF-SIG fields may be formatted in accordance with an IEEE 802.11 standard. In some examples, the AF preamble 820 may have the same duration or format as the Wi-Fi legacy preamble 810.

The L-SIG may include a length field identifying a first duration for which a radio frequency spectrum is reserved. The AF-SIG may include a length field identifying a second duration for which the radio frequency spectrum is reserved. The second duration may be less than the first duration by the combined durations of the Wi-Fi legacy preamble 810 and the Wi-Fi HE preamble 815. In some embodiments, the AF preamble 820 may be transmitted with the length field of the AF-SIG indicating the second duration or the first duration, or with the length field being a placeholder, and an intended receiver of the sequence of preambles 805 may replace the length field with a duration before (or when) it forwards the AF preamble 820.

The H-SIG may include an indication that the AF preamble 820 is present and an indication of an intended receiver (or receivers) for the sequence of preambles 805. When a receiver receives the sequence of preambles 805 and determines that it is an intended receiver of the sequence of preambles 805, the receiver may amplify the AF preamble 820 and forward the content of the AF preamble 820 to other wireless devices. Another wireless device that receives the AF preamble 820 may be caused to refrain from transmitting during the second duration identified in the AF-SIG of the AF preamble 820.

In some embodiments, the AF preamble 820 may be extended to include an X field at the beginning of the AF preamble 820 or a Y field at an end of the AF preamble 820. Alternatively, the X field may be considered to be a field that is transmitted between the Wi-Fi HE preamble 815 and the AF preamble 820, and/or the Y field may be considered a field that is transmitted following the AF preamble 820. In either case, the X field or Y field may be used for a null transmission, and may provide time for an intended receiver of the sequence of preambles 805 to switch from a “receive and process” mode to an “amplify and forward” mode.

Although the AF preamble 820 is shown to be a substantial replica of the Wi-Fi legacy preamble 810 (with possible additions of the X field and the Y field), the AF preamble 820 could also take other forms. For example, the AF preamble 820 may be configured in accordance with a different RAT than the Wi-Fi legacy preamble 810 and the Wi-Fi HE preamble 815 (e.g., the AF preamble 820 may include a VHT preamble or an LTE/LTE-A preamble).

In some embodiments, a transmitter may transmit the Wi-Fi legacy preamble 810 and the Wi-Fi HE preamble 815, and then monitor the radio frequency spectrum over which the preambles 810 and 815 are transmitted for an AF preamble transmitted by an intended receiver of the sequence of preambles 805. Upon receiving the AF preamble, the transmitter may interpret the received AF preamble as an indication that the intended receiver is available to receive the number of payloads 825.

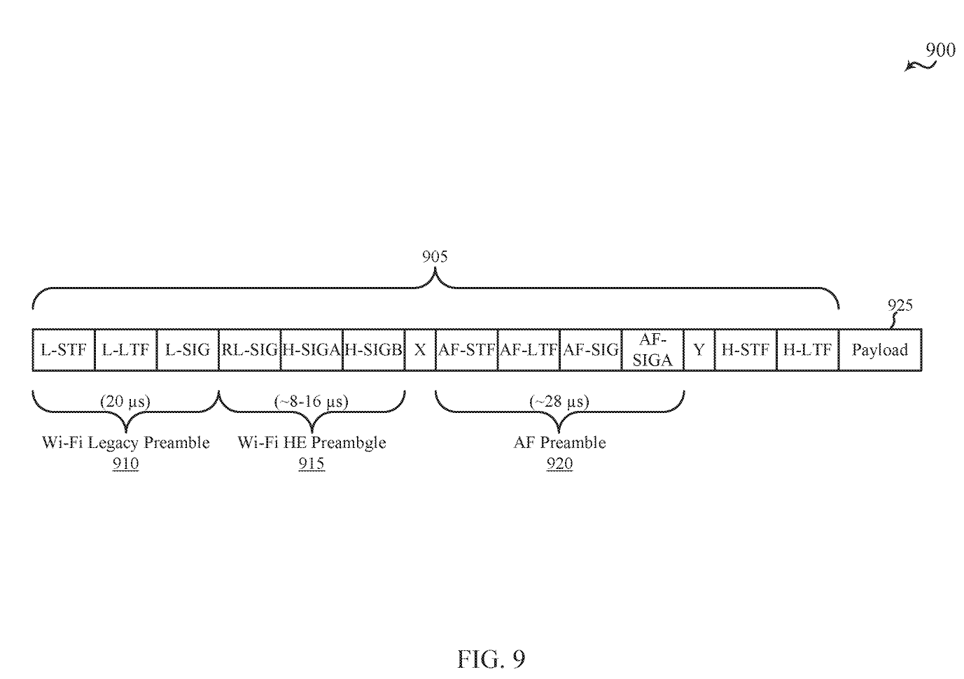

FIG. 9 is a timing diagram 900 illustrating transmission of a sequence of preambles 905, in accordance with various aspects of the present disclosure. In some examples, the sequence of preambles 905 may be an example of aspects of the sequence of preambles transmitted (or received) by any of the wireless devices or apparatuses 115 described with reference to FIGS. 1-6.

By way of example, the sequence of preambles 905 is shown to include a Wi-Fi legacy preamble 910, followed by a Wi-Fi HE preamble 915, followed by an AF preamble 920. A number of payloads 925 may follow the AF preamble 920. The Wi-Fi legacy preamble 910 may include L-STF, L-LTF, and L-SIG fields. The Wi-Fi HE preamble 915 may include the signal fields labeled RL-SIG, H-SIGA, and H-SIGB. The AF preamble 920 may include AF-STF, AF-LTF, and AF-SIG fields, and an additional AF signal field (AF-SIGA). In some embodiments, each of the L-STF, L-LTF, L-SIG, RL-SIG, H-SIGA, H-SIGB, AF-STF, AF-LTF, AF-SIG, and AF-SIGA fields may be formatted in accordance with an IEEE 802.11 standard.

The L-SIG may include a length field identifying a first duration for which a radio frequency spectrum is reserved. The AF-SIG may include a length field identifying a second duration for which the radio frequency spectrum is reserved. The second duration may be less than the first duration by the combined durations of the Wi-Fi legacy preamble 910 and the Wi-Fi HE preamble 915. In some embodiments, the AF preamble 920 may be transmitted with the length field of the AF-SIG indicating the second duration or the first duration, or with the length field being a placeholder, and an intended receiver of the sequence of preambles 905 may replace the length field with a duration before (or when) it forwards the AF preamble 920.

The H-SIGA or H-SIGB may include an indication that the AF preamble 920 is present and an indication of an intended receiver (or receivers) for the sequence of preambles 905. When a receiver receives the sequence of preambles 905 and determines that it is an intended receiver of the sequence of preambles 905, the receiver may amplify the AF preamble 920 and forward the content of the AF preamble 920 to other wireless devices. Another wireless device that receives the AF preamble 920 may be caused to refrain from transmitting during the second duration identified in the AF-SIG of the AF preamble 920.

In some embodiments, the AF preamble 920 may be extended to include an X field or Y field, as described with reference to FIG. 8.

In some embodiments, the sequence of preambles 905 may include a number of fields (e.g., an H-STF and/or H-LTF field) that may be used for offset correction (e.g., by a receiver) following the AF preamble 920.

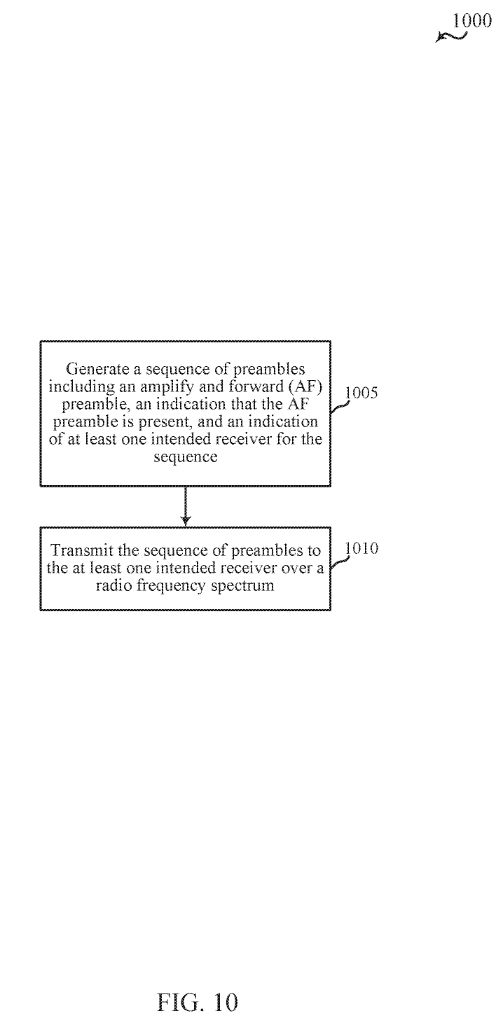

FIG. 10 is a flow chart illustrating an example of a method 1000 for wireless communication, in accordance with various aspects of the present disclosure. For clarity, the method 1000 is described below with reference to aspects of the wireless devices or apparatuses 115 described with reference to FIGS. 1-6. In some examples, a wireless device and/or apparatus may execute sets of codes to control the functional elements of the wireless device and/or apparatus to perform the functions described below. Additionally or alternatively, the wireless device and/or apparatus may perform the functions described below using special-purpose hardware.

At block 1005, the method 1000 may include generating a sequence of preambles including an AF preamble, an indication that the AF preamble is present, and an indication of an intended receiver (or receivers) for the sequence. At block 1010, the method 1000 may include transmitting the sequence of preambles to the intended receiver(s) over a radio frequency spectrum.

The operations at blocks 1005 and 1010 may be performed using the wireless communication manager 220 described with reference to FIG. 1, the receiver 210, wireless communication manager 220, or transmitter 230 described with reference to FIGS. 2-5, or the at least one radio 630, wireless communication manager 220-f, or processor 610 described with reference to FIG. 6. In some examples, the sequence of preambles may be formatted as described with reference to any of FIGS. 7-9.

Thus, the method 1000 may provide for wireless communication. It should be noted that the method 1000 is just one implementation and that the operations of the method 1000 may be rearranged or otherwise modified such that other implementations are possible.

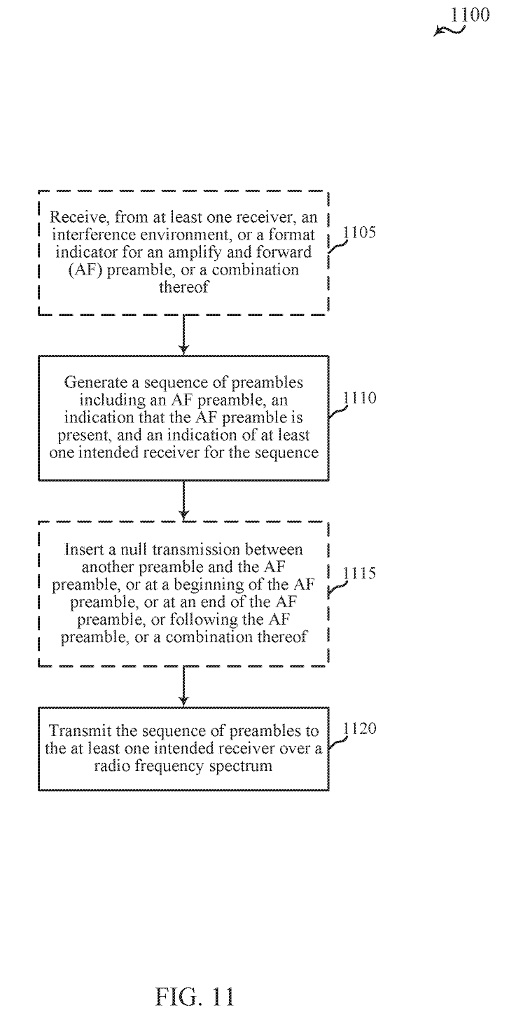

FIG. 11 is a flow chart illustrating an example of a method 1100 for wireless communication, in accordance with various aspects of the present disclosure. For clarity, the method 1100 is described below with reference to aspects of the wireless devices or apparatuses 115 described with reference to FIGS. 1-6. In some examples, a wireless device and/or apparatus may execute sets of codes to control the functional elements of the wireless device and/or apparatus to perform the functions described below. Additionally or alternatively, the wireless device and/or apparatus may perform the functions described below using special-purpose hardware.

At block 1105, the method 1100 may optionally include receiving, from at least one receiver, at least one indicator of an interference environment, a format indicator for an AF preamble, or a combination thereof.

At block 1110, the method 1100 may include generating a sequence of preambles including an AF preamble, an indication that the AF preamble is present, and an indication of an intended receiver (or receivers) for the sequence. In some examples, generating the sequence of preambles may include identifying, in the sequence of preambles, a first duration for which the radio frequency spectrum is reserved. Generating the sequence of preambles may also include identifying, in the AF preamble, a second duration for which the radio frequency spectrum is reserved, wherein the second duration is less than the first duration by at least a time period of one preamble in the sequence of preambles. Alternatively, the first duration or the second duration may be identified in the AF preamble, or a placeholder may be included in the AF preamble, and an intended receiver may replace the first duration, the second duration, or the placeholder with a duration determined by the intended receiver.

In some embodiments of the method 1100, the format of the AF preamble may be selected based on a format indicator for the AF preamble (e.g., based on a format indicator received from an intended receiver at block 1105). In some embodiments of the method 1100, the format of the AF preamble may be selected based on an indicator (or indicators) of an interference environment (e.g., based at least in part an indicator of the type or quantity of interference that may be experienced by the intended receiver(s) of the sequence of preambles). In some cases, the indicator(s) of the interference environment may be received from at least one of the intended receivers. In some cases, the indicator(s) of the interference environment may be received from other receivers or devices, or from a combination of intended receivers, other receives, and/or other devices.

In some embodiments of the method 1100, the sequence of preambles may include a Wi-Fi legacy preamble and a Wi-Fi HE preamble. In these embodiments, the first duration for which the radio frequency spectrum is reserved may be identified in a length field of the Wi-Fi legacy preamble, and the second duration, if provided, may be identified in a length field of the AF preamble. In some cases, the Wi-Fi legacy preamble and the AF preamble may have a same duration or format. In other cases, the Wi-Fi legacy preamble and the AF preamble may have different durations or formats. In some cases, the AF preamble may include a replica of at least one field of a preamble in the sequence of preambles (e.g., a replica of at least one field of the Wi-Fi legacy preamble). In some cases, the AF preamble may be a substantial replica of the Wi-Fi legacy preamble. For example, the AF preamble may include the same fields as the Wi-Fi legacy preamble and have the same duration as the Wi-Fi legacy preamble. However, the AF preamble may have a length field indicating the second duration for which the radio frequency spectrum is reserved instead of the first duration.

In some embodiments of the method 1100, the sequence of preambles may include at least one preamble configured according to a first RAT of the intended receiver(s), and the AF preamble may include a preamble recognizable to a receiver operating according to a second RAT. For example, in embodiments in which the sequence of preambles includes a Wi-Fi legacy preamble and a Wi-Fi HE preamble configured according to a Wi-Fi RAT of the intended receiver(s), the AF preamble may include a VHT preamble or an LTE/LTE-A preamble.

In some embodiments, the sequence of preambles may include an offset correction following the AF preamble.

At block 1115, the method 1100 may optionally include inserting a null transmission between another preamble and the AF preamble, at a beginning of the AF preamble, at an end of the AF preamble, following the AF preamble, or a combination thereof.

At block 1120, the method 1100 may include transmitting the sequence of preambles to the intended receiver(s) over a radio frequency spectrum.

The operations at blocks 1105, 1110, 1115, and 1120 may be performed using the wireless communication manager 220 described with reference to FIG. 1, the receiver 210, wireless communication manager 220, or transmitter 230 described with reference to FIGS. 2-5, or the at least one radio 630, wireless communication manager 220-f, or processor 610 described with reference to FIG. 6. In some examples, the sequence of preambles may be formatted as described with reference to any of FIGS. 7-9.

Thus, the method 1100 may provide for wireless communication. It should be noted that the method 1100 is just one implementation and that the operations of the method 1100 may be rearranged or otherwise modified such that other implementations are possible.

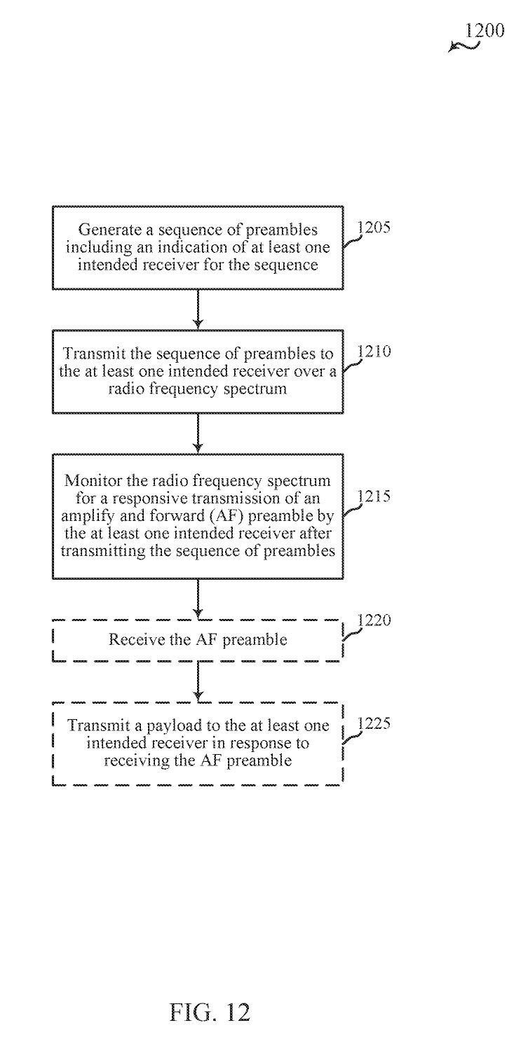

FIG. 12 is a flow chart illustrating an example of a method 1200 for wireless communication, in accordance with various aspects of the present disclosure. For clarity, the method 1200 is described below with reference to aspects of the wireless devices or apparatuses 115 described with reference to FIGS. 1-6. In some examples, a wireless device and/or apparatus may execute sets of codes to control the functional elements of the wireless device and/or apparatus to perform the functions described below. Additionally or alternatively, the wireless device and/or apparatus may perform the functions described below using special-purpose hardware.

At block 1205, the method 1200 may include generating a sequence of preambles including an indication of an intended receiver (or receivers) for the sequence. At block 1210, the method 1200 may include transmitting the sequence of preambles to the intended receiver(s) over a radio frequency spectrum. At block 1215, the method 1200 may include monitoring the radio frequency spectrum for a responsive transmission of an AF preamble by the intended receiver(s) after transmitting the sequence of preambles.

At block 1220, the method 1200 may optionally include receiving the AF preamble. Receipt of the AF preamble, from a receiver, may be considered an indication that the receiver is available to receive a transmission. At block 1225, the method 1200 may optionally include transmitting a payload to the intended receiver(s) in response to receiving the AF preamble.

In some examples, generating the sequence of preambles may include identifying, in the sequence of preambles, a duration for which the radio frequency spectrum is reserved.

In some embodiments of the method 1200, the sequence of preambles may include a Wi-Fi legacy preamble and a Wi-Fi HE preamble. In these embodiments, the duration for which the radio frequency spectrum is reserved may be identified in a length field of the Wi-Fi legacy preamble.

The operations at blocks 1205, 1210, 1215, 1220 and 1225 may be performed using the wireless communication manager 220 described with reference to FIG. 1, the receiver 210, wireless communication manager 220, or transmitter 230 described with reference to FIGS. 2-5, or the at least one radio 630, wireless communication manager 220-f, or processor 610 described with reference to FIG. 6. In some examples, the sequence of preambles may be formatted as described with reference to any of FIGS. 7-9.

Thus, the method 1200 may provide for wireless communication. It should be noted that the method 1200 is just one implementation and that the operations of the method 1200 may be rearranged or otherwise modified such that other implementations are possible.

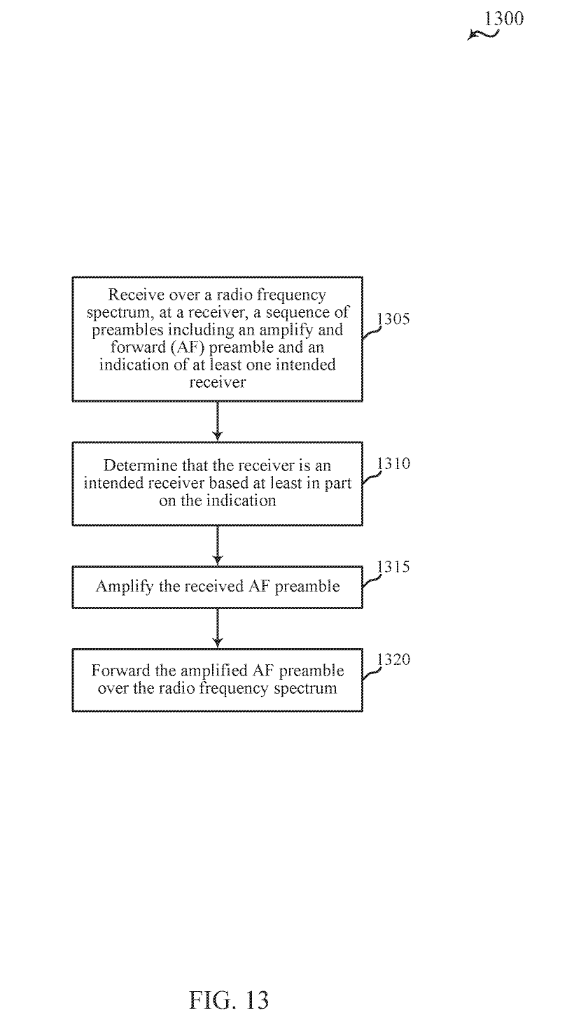

FIG. 13 is a flow chart illustrating an example of a method 1300 for wireless communication, in accordance with various aspects of the present disclosure. For clarity, the method 1300 is described below with reference to aspects of the wireless devices or apparatuses 115 described with reference to FIGS. 1-6. In some examples, a wireless device and/or apparatus may execute sets of codes to control the functional elements of the wireless device and/or apparatus to perform the functions described below. Additionally or alternatively, the wireless device and/or apparatus may perform the functions described below using special-purpose hardware.

At block 1305, the method 1300 may include receiving over a radio frequency spectrum, at a receiver, a sequence of preambles including an AF preamble and an indication of an intended receiver (or receivers). At block 1310, the method 1300 may include determining that the receiver is an intended receiver based on the indication. At block 1315, the method 1300 may include amplifying the received AF preamble. At block 1320, the method 1300 may include forwarding the amplified AF preamble over the radio frequency spectrum.

The operations at blocks 1305, 1310, 1315, and 1320 may be performed using the wireless communication manager 220 described with reference to FIG. 1, the receiver 210, wireless communication manager 220, or transmitter 230 described with reference to FIGS. 2-5, or the at least one radio 630, wireless communication manager 220-f, or processor 610 described with reference to FIG. 6. In some examples, the sequence of preambles may be formatted as described with reference to any of FIGS. 7-9.

Thus, the method 1300 may provide for wireless communication. It should be noted that the method 1300 is just one implementation and that the operations of the method 1300 may be rearranged or otherwise modified such that other implementations are possible.

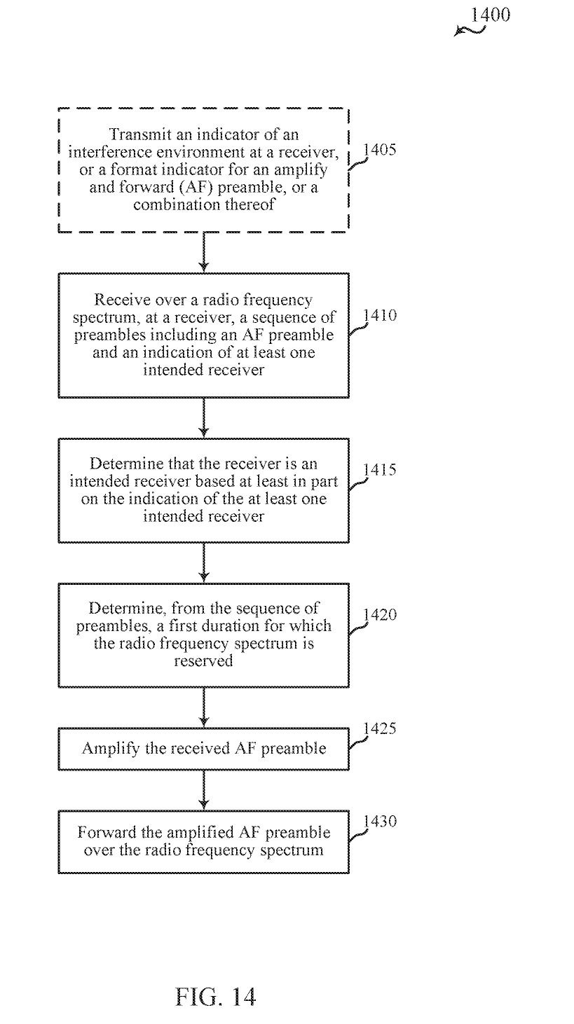

FIG. 14 is a flow chart illustrating an example of a method 1400 for wireless communication, in accordance with various aspects of the present disclosure. For clarity, the method 1400 is described below with reference to aspects of the wireless devices or apparatuses 115 described with reference to FIGS. 1-6. In some examples, a wireless device and/or apparatus may execute sets of codes to control the functional elements of the wireless device and/or apparatus to perform the functions described below. Additionally or alternatively, the wireless device and/or apparatus may perform the functions described below using special-purpose hardware.

At block 1405, the method 1400 may optionally include transmitting an indicator of an interference environment at a receiver, a format indicator for an AF preamble, or a combination thereof.

At block 1410, the method 1400 may include receiving over a radio frequency spectrum, at a receiver, a sequence of preambles including an AF preamble and an indication of an intended receiver (or receivers). In some embodiments, the sequence of preambles may also include at least one of an indicator that the AF preamble is present or an indicator of a first duration for which a radio frequency spectrum is reserved. The AF preamble may include an indicator of a second duration for which the radio frequency spectrum is reserved. Alternatively, the first duration or the second duration may be identified in the AF preamble, or a placeholder may be included in the AF preamble, and the receiver may replace the first duration, the second duration, or the placeholder with a duration determined by the receiver. The second duration may be less than the first duration by at least a time period of one preamble in the sequence of preambles. In some cases, the received AF preamble may have a format based on the interference environment indicated at block 1405 or associated with the format indicator transmitted at block 1405.

In some embodiments of the method 1400, the sequence of preambles may include a Wi-Fi legacy preamble and a Wi-Fi HE preamble. In these embodiments, the first duration for which the radio frequency spectrum is reserved may be identified in a length field of the Wi-Fi legacy preamble, and the second duration, if provided, may be identified in a length field of the AF preamble. In some cases, the Wi-Fi legacy preamble and the AF preamble may have a same duration or format. In other cases, the Wi-Fi legacy preamble and the AF preamble may have different durations or formats. In some cases, the AF preamble may include a replica of at least one field of a preamble in the sequence of preambles (e.g., a replica of at least one field of the Wi-Fi legacy preamble). In some cases, the AF preamble may be a substantial replica of the Wi-Fi legacy preamble. For example, the AF preamble may include the same fields as the Wi-Fi legacy preamble and have the same duration as the Wi-Fi legacy preamble. However, the AF preamble may have a length field indicating the second duration for which the radio frequency spectrum is reserved instead of the first duration.

In some embodiments of the method 1400, the sequence of preambles may include at least one preamble configured according to a first RAT of the receiver, and the AF preamble may include a preamble recognizable to a receiver operating according to a second RAT. For example, in embodiments in which the sequence of preambles includes a Wi-Fi legacy preamble and a Wi-Fi HE preamble configured according to a Wi-Fi RAT of the receiver, the AF preamble may include a VHT preamble or an LTE/LTE-A preamble recognizable by an LTE/LTE-A receiver operating within an energy detection range of the receiver performing the method 1400.

In some embodiments, the sequence of preambles may include an offset correction following the AF preamble. In some embodiments, the operation(s) at block 1410 may further include receiving a null transmission between one preamble and the AF preamble, at a beginning of the AF preamble, at an end of the AF preamble, following the AF preamble, or a combination thereof.

At block 1415, the method 1400 may include determining that the receiver is an intended receiver based on the indication of the intended receiver(s).

At block 1420, the method 1400 may include determining, from the sequence of preambles, the first duration for which the radio frequency spectrum is reserved. At block 1425, the method 1400 may optionally include inserting, in the AF preamble, the second duration for which the radio frequency spectrum is reserved. In some embodiments, the AF preamble may already include the second duration.

At block 1425, the method 1400 may include amplifying the received AF preamble.

At block 1430, the method 1400 may include forwarding the amplified AF preamble over the radio frequency spectrum.

The operations at blocks 1405, 1410, 1415, 1420, 1425, and 1430 may be performed using the wireless communication manager 220 described with reference to FIG. 1, the receiver 210, wireless communication manager 220, or transmitter 230 described with reference to FIGS. 2-5, or the at least one radio 630, wireless communication manager 220-f, or processor 610 described with reference to FIG. 6. In some examples, the sequence of preambles may be formatted as described with reference to any of FIGS. 7-9.

Thus, the method 1400 may provide for wireless communication. It should be noted that the method 1400 is just one implementation and that the operations of the method 1400 may be rearranged or otherwise modified such that other implementations are possible.

The detailed description set forth above in connection with the appended drawings describes examples and does not represent all of the examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, at least one microprocessor in conjunction with a DSP core, or any other such configuration.

The functions described herein may be implemented in hardware, software executed by a processor, firmware, or any combination thereof. If implemented in software executed by a processor, the functions may be stored on or transmitted as instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Throughout this disclosure the term “example” or “exemplary” indicates an example or instance and does not imply or require any preference for the noted example. Thus, the disclosure is not to be limited to the examples and designs described herein but is to be accorded the broadest scope consistent with the principles and novel features disclosed herein.

What is claimed is:

1. A method for wireless communication, comprising:
generating a sequence of preambles comprising an amplify and forward (AF) preamble, an indication that the AF preamble is present, and an indication of at least one intended receiver for the sequence; and
transmitting the sequence of preambles to the at least one intended receiver over a radio frequency spectrum.

2. The method of claim 1, wherein the AF preamble comprises a replica of at least one field of a preamble in the sequence of preambles.

3. The method of claim 1, wherein:
the sequence of preambles comprises at least one preamble configured according to a first radio access technology (RAT) of the at least one intended receiver; and
the AF preamble comprises a preamble recognizable to a receiver operating according to a second RAT.

4. The method of claim 1, further comprising:
identifying, in the sequence of preambles, a first duration for which the radio frequency spectrum is reserved; and
identifying, in the AF preamble, a second duration for which the radio frequency spectrum is reserved, wherein the second duration is less than the first duration by at least a time period of one preamble in the sequence of preambles.

5. The method of claim 1, wherein the sequence of preambles comprises a Wi-Fi legacy preamble and a Wi-Fi high efficiency (HE) preamble.

6. The method of claim 5, wherein the Wi-Fi legacy preamble and the AF preamble have a same duration.

7. The method of claim 1, further comprising:
receiving, from at least one receiver, at least one indicator of an interference environment; and
selecting a format of the AF preamble based at least in part on the at least one indicator of the interference environment.

8. The method of claim 1, further comprising:
receiving, from the at least one intended receiver, a format indicator for the AF preamble; and
selecting a format of the AF preamble based at least in part on the format indicator.

9. The method of claim 1, further comprising:
inserting a null transmission between another preamble and the AF preamble, or at a beginning of the AF preamble, or at an end of the AF preamble, or following the AF preamble, or a combination thereof.

10. The method of claim 1, wherein the sequence of preambles comprises an offset correction following the AF preamble.

11. A method for wireless communication, comprising:
generating a sequence of preambles comprising an indication of at least one intended receiver for the sequence;
transmitting the sequence of preambles to the at least one intended receiver over a radio frequency spectrum; and
monitoring the radio frequency spectrum for a responsive transmission of an amplify and forward (AF) preamble by the at least one intended receiver after transmitting the sequence of preambles.

12. The method of claim 11, further comprising:
receiving the AF preamble; and
transmitting a payload to the at least one intended receiver in response to receiving the AF preamble.

13. A method for wireless communication, comprising:
receiving over a radio frequency spectrum, at a receiver, a sequence of preambles comprising an amplify and forward (AF) preamble and an indication of at least one intended receiver;
determining that the receiver is an intended receiver based at least in part on the indication;
amplifying the received AF preamble; and
forwarding the amplified AF preamble over the radio frequency spectrum.

14. The method of claim 13, wherein the AF preamble comprises a replica of at least one field of a preamble in the sequence of preambles.

15. The method of claim 13, further comprising:
determining, from the sequence of preambles, a first duration for which the radio frequency spectrum is reserved; and
inserting, in the AF preamble, a second duration for which the radio frequency spectrum is reserved, wherein the second duration is less than the first duration by at least a time period of one preamble in the sequence of preambles.

16. The method of claim 13, wherein the sequence of preambles comprises a Wi-Fi legacy preamble and a Wi-Fi high efficiency (HE) preamble.

17. The method of claim 16, wherein the Wi-Fi legacy preamble and the AF preamble have a same duration.

18. The method of claim 13, further comprising:
transmitting at least one indicator of an interference environment at the receiver, wherein the received AF preamble comprises a format based at least in part on the interference environment.

19. The method of claim 13, further comprising:
receiving a null transmission between one preamble and the AF preamble, or at a beginning of the AF preamble, or at an end of the AF preamble, or following the AF preamble, or a combination thereof.

20. The method of claim 13, wherein the sequence of preambles comprises an offset correction following the AF preamble.
